(19) United States
(12) Patent Application Publication
(10) Pub. No.: US 2016/0333967 A1
(43) Pub. Date: Nov. 17, 2016

(54) HYBRID TRANSMISSION FOR VEHICLE

(71) Applicant: Hyundai Motor Company, Seoul (KR)

(72) Inventors: Jong Yun PARK, Gyeonggi-do (KR); Jae Young CHOI, Busan (KR); Kyung Ha KIM, Gyeonggi-do (KR); Ki Nam KIM, Gyeonggi-do (KR)

(21) Appl. No.: 14/885,650

(22) Filed: Oct. 16, 2015

(30) Foreign Application Priority Data
May 14, 2015 (KR) 10-2015-0067243

(51) Int. Cl. F16H 3/085; B60K 6/387; B60K 6/547

(52) U.S. Cl. CPC F16H 3/085; B60K 6/547; B60K 6/387; Y10S 903/919; Y10S 903/914; B60Y 2200/92; B60Y 2400/71

(57) ABSTRACT

A hybrid transmission for a vehicle. A first input shaft receives power from an engine through an engine clutch. A second input shaft is coaxial with the first input shaft and connected to a motor. A shaft-coupling unit connects or disconnects the first input shaft and the second input shaft. A first output shaft and a second output shaft are respectively disposed parallel to the first input shaft and the second input shaft. A plurality of shifting units or constantly-engaging shifting mechanisms are provided on the first input shaft and the first output shaft, on the first input shaft and the second output shaft, and on the second input shaft and the second output shaft, thereby forming a series of shifting stages, wherein shifting ratios of the series of shifting stages decrease with increasing numerical values of the series of shifting stages.

### CROSS-REFERENCE TO RELATED APPLICATIONS

This application claims the benefit of Korean Patent Application No. 10-2015-0067243, filed on May 14, 2015, the entirety of which is hereby incorporated by reference.

### FIELD

The present disclosure generally relates to a hybrid transmission for a vehicle, and namely to the configuration of a hybrid transmission based on an automated manual transmission (AMT).

### BACKGROUND

The statements in this section merely provide background information related to the present disclosure and may not constitute prior art.

An automated manual transmission (AMT) is a competitive transmission among a variety of transmissions mounted to vehicles, considering the price, weight, fuel efficiency, and the like. However, the marketability of the AMT is lowered due to toque interruption occurring during shifting, so the AMT has not been widely distributed.

Some existing ATMs have attempted to overcome the problem of torque interruption by adding a motor. While such ATMs maintain the advantages of the AMT, we have discovered that they provide a poor sensation of shifting and the layout thereof is unfavorable.

### SUMMARY

The present disclosure provides a hybrid transmission for a vehicle capable of maintaining the advantages of an automated manual transmission (AMT) of the related art, while also efficiently removing torque interruption, thereby improving the sensation of shifting and improving the fuel efficiency of the vehicle.

According to one form of the present disclosure, a hybrid transmission for a vehicle includes: an engine clutch connecting and disconnecting an engine to and from the transmission; a first input shaft receiving power from the engine through the engine clutch; a second input shaft coaxial with the first input shaft and connected to a motor; a shaft-coupling unit connecting or disconnecting the first input shaft and the second input shaft; a first output shaft and a second output shaft respectively disposed parallel to the first input shaft and the second input shaft; and a plurality of shifting units. The plurality of shifting units are constantly-engaging shifting mechanisms provided on the first input shaft and the first output shaft, on the first input shaft and the second output shaft, and on the second input shaft and the second output shaft, thereby forming a series of shifting stages, wherein shifting ratios of the series of shifting stages decrease with increasing numerical values of the series of shifting stages such that a first shifting stage has a greatest shifting ratio. That is, the shifting units or mechanisms are always in engagement with two of the first input shaft, the first output shaft, the second input shaft and the second output shaft, and selectively employed for torque transmission. The shifting units forming odd-numbered shifting stages of the series of shifting stages are disposed such that the odd-numbered shifting stages are realized by the first input shaft, and the shifting units forming even-numbered shifting stages of the series of shifting stages between the odd-numbered shifting stages are disposed such that the even-numbered shifting stages are realized by the second input shaft.

The shaft-coupling unit may be implemented as a center synchronizer engaging or disengaging the first input shaft and the second input shaft while synchronizing the first input shaft and the second input shaft by absorbing a difference in rotation speed therebetween.

Each of the shifting units may include a driving gear, a driven gear engaged with the driving gear, and a synchronizer connecting or disconnecting one of the driving gear and the driven gear to or from a shaft on which one of the driving gear and the driven gear is disposed.

The plurality of shifting units may include first to sixth shifting units to form first to sixth shifting stages. The first shifting unit forming the first shifting stage and the third shifting unit forming the third shifting stage are disposed on the first input shaft and the first output shaft. The fifth shifting unit forming the fifth shifting stage and the sixth shifting unit forming the sixth shifting stage are disposed on the first input shaft and the second output shaft. The second shifting unit forming the second shifting stage and the fourth shifting unit forming the fourth shifting stage are disposed on the second input shaft and the second output shaft.

The first shifting unit and the third shifting unit may form a synchronizer commonly using a first/third stage hub and a first/third stage sleeve on the first output shaft. The second shifting unit and the fourth shifting unit may form a synchronizer commonly using a second/fourth stage hub and a second/fourth stage sleeve on the second input shaft. The fifth shifting unit and the sixth shifting unit may form a synchronizer commonly using a fifth/sixth stage hub and a fifth/sixth stage sleeve on the second output shaft.

A first output gear may be integrally disposed on the first output shaft. A second output gear may be integrally disposed on the second output shaft. A third output gear may be engaged with the first and second output gears in order to receive power therefrom.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagram illustrating the configuration of a hybrid transmission of a vehicle according to one form of the present disclosure;

FIGS. 2 to 8 are diagrams sequentially illustrating the process of shifting from the first shifting stage to the second shifting stage according to the form shown in FIG. 1;

FIGS. 9 to 12 are diagrams sequentially illustrating the process of shifting from the second shifting stage to the third shifting stage according to the form shown in FIG. 1;

FIGS. 13 to 18 are diagrams sequentially illustrating the process of shifting from the third shifting stage to the fourth shifting stage according to the form shown in FIG. 1;

FIGS. 19 to 23 are diagrams sequentially illustrating the process of shifting from the fourth shifting stage to the fifth shifting stage according to the form shown in FIG. 1; and

FIGS. 24 to 29 are diagrams sequentially illustrating the states of first to sixth shifting stages of Electric Vehicle (EV) mode enabled by only the motor according to an exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts or features.

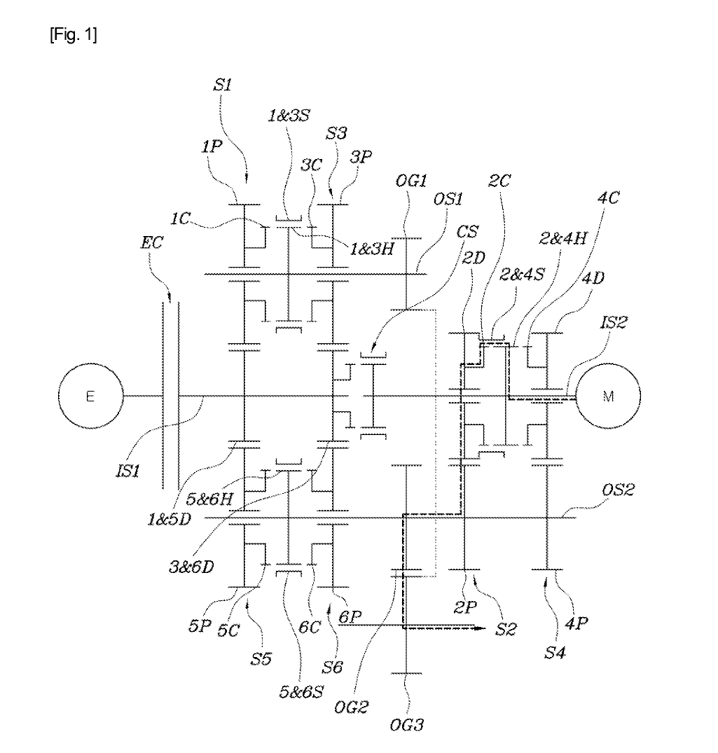

Referring to FIG. 1, a hybrid transmission for a vehicle according to an one form of the present disclosure includes: an engine clutch EC connecting and disconnecting an engine E and the transmission; a first input shaft IS1 receiving power from the engine E through the engine clutch EC; a second input shaft IS2 coaxial with the first input shaft IS1 and connected to a motor M; a shaft-coupling unit connecting or disconnecting the first input shaft IS1 and the second input shaft IS2; a first output shaft OS1 and a second output shaft OS2 respectively disposed parallel to the first input shaft IS1 and the second input shaft IS2; and a plurality of shifting units provided as constantly-engaging shifting mechanisms on the first input shaft IS1 and the first output shaft OS1, on the first input shaft IS1 and the second output shaft OS2, and on the second input shaft IS2 and the second output shaft OS2, thereby forming a series of shifting stages, wherein the shifting ratios of the series of shifting stages decrease with increasing numerical values of the series of shifting stages such that the shifting ratio of a first shifting stage of the series of shifting stages is greatest.

According to this form of the present disclosure, the first input shaft IS1 rotated by power from the engine and the second input shaft IS2 rotated by the motor M are arranged coaxially. The shaft-coupling unit is configured to connect and disconnect the first input shaft IS1 and the second input shaft IS2. The plurality of shifting units is provided on the first input shaft IS1, the first output shaft OS1, the second input shaft IS2, and the second output shaft OS2.

The shifting units forming the odd-numbered shifting stages are disposed such that the odd-numbered shifting stages are realized by the first input shaft IS1. Among the shifting units forming the even-numbered shifting stages, the shifting units forming the even-numbered shifting stages between the odd-numbered shifting stages are disposed such that the even-numbered shifting stages are realized by the second input shaft IS2.

For example, when the transmission has first to sixth shifting stages as in one form of the present disclosure, the shifting units forming the odd-numbered shifting stages, i.e. the first, third, and fifth shifting stages, are provided on the first input shaft IS1, the first output shaft OS1, the second input shaft IS2, and the second output shaft OS2. The shifting units forming the second and fourth shifting stages, i.e. the even-numbered shifting stages positioned between the odd-numbered shifting stages of the first, third, and fifth shifting stages, are disposed on the second input shaft IS2 and the second output shaft OS2. The shifting unit forming the sixth shifting stage, i.e. the even-numbered shifting stage that is not positioned between the odd-numbered shifting stages, is disposed on the first input shaft IS1 and the second output shaft OS2 instead of being disposed on the second input shaft IS2.

The arrangement of the shifting units as described above is intended to facilitate gear changing while preventing torque interruption during the gear changing, thereby improving gear-changing quality.

The shaft-coupling unit is implemented as a center synchronizer CS that is a synchronizer configured to engage or disengage the first input shaft IS1 and the second input shaft IS2 while synchronizing the first input shaft IS1 and the second input shaft IS2 by absorbing the difference in the rotation speed therebetween.

Each of the shifting units includes a driving gear, a driven gear engaged with the driving gear, and a synchronizer able to connect or disconnect one of the driving gear and the driven gear to or from a shaft on which one of the driving gear or the driven gear is disposed.

According to one form of the present disclosure, the plurality of shifting units are provided as six shifting units in order to form the first to sixth shifting stages. The first shifting unit S1 forming the first shifting stage and the third shifting unit S3 forming the third shifting stage are disposed on the first input shaft IS1 and the first output shaft OS1. The fifth shifting unit S5 forming the fifth shifting stage and the sixth shifting unit S6 forming the sixth shifting stage are disposed on the first input shaft IS1 and the second output shaft OS2. The second shifting unit S2 forming the second shifting stage and the fourth shifting unit S4 forming the fourth shifting stage are disposed on the second input shaft IS2 and the second output shaft OS2.

According to the present embodiment, the first shifting unit S1 and the third shifting unit S3 form a synchronizer commonly using a first/third stage hub 1&3H and a first/third stage sleeve 1&3S on the first output shaft OS1. The second shifting unit S2 and the fourth shifting unit S4 form a synchronizer commonly using a second/fourth stage hub 2&4H and a second/fourth stage sleeve 2&4S on the second input shaft IS2. The fifth shifting unit S5 and the sixth shifting unit S6 form a synchronizer commonly using a fifth/sixth stage hub 5&6H and a fifth/sixth stage sleeve 5&6S on the second output shaft OS2.

In addition, the first shifting stage and the fifth shifting stage are formed using a common driving gear, which is referred to as a first/fifth stage driving gear 1&5D, and the third shifting stage and the sixth shifting stage are formed using a common driving gear, which is referred to as a third/sixth stage driving gear 3&6D.

Thus, the first shifting unit S1 and the third shifting unit S3 include the first/fifth stage driving gear 1&5D and a first stage driven gear 1P for forming the first shifting stage, a first stage clutch gear 1C integrally disposed on the first stage driven gear 1P, the third/sixth stage driving gear 3&6D and a third stage driven gear 3P for forming the third shifting stage, a third stage clutch gear 3C integrally disposed on the third stage driven gear 3P, the first/third stage hub 1&3H, and the first/third stage sleeve 1&3S.

Likewise, the second stage shifting unit S2 and the fourth stage shifting unit S4 includes a second stage driving gear 2D and a second stage driven gear 2P for forming the second shifting stage, a second stage clutch gear 2C integrally disposed on the second stage driven gear 2P, a fourth stage driving gear 4D and a fourth stage driven gear 4P for forming a fourth shifting stage, a fourth stage clutch gear 4C integrally disposed on the fourth stage driven gear 4P, the second/fourth stage hub 2&4H, and the second/fourth stage sleeve 2&4S.

In addition, the fifth stage shifting unit S5 and the sixth stage shifting unit S6 include the first/fifth stage driving gear 1&5D and a fifth stage driven gear 5P for forming the fifth shifting stage, a fifth stage clutch gear 5C integrally disposed on the fifth stage driven gear 5P, the third/sixth stage driving gear 3&6D and a sixth stage driven gear 6P for forming the sixth shifting stage, a sixth stage clutch gear 6C integrally disposed on the sixth driven gear 6P, the fifth/sixth stage hub 5&6H, and the fifth/sixth stage sleeve 5&6S.

A first output gear OG1 is integrally disposed on the first output shaft OS1, and a second output gear OG2 is integrally disposed on the second output shaft OS2. A third output gear OG3 is engaged with the first and second output gears OG1 and OG2 in order to receive power therefrom. The third output gear OG3 may be implemented as a differential ring gear or the like.

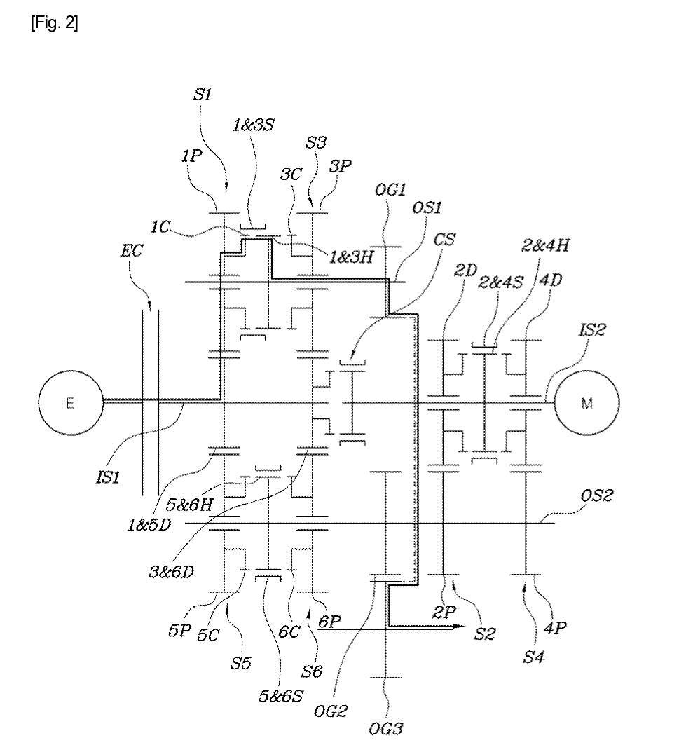

A description of a process of shifting from the first shifting stage to the second shifting stage will be given below with reference to FIGS. 2 to 8.

FIG. 2 illustrates a state in which the transmission realizes the first shifting stage. Power from the engine E is transmitted to the first input shaft IS1 through the engine clutch EC. Here, since the first/third stage sleeve 1&3S is engaged with the first stage clutch gear 1C, first stage power produced by the first/fifth stage driving gear 1&5D and the first stage driven gear 1P is induced to the third output gear OG3 through the first output shaft OS1 and the first output gear OG1

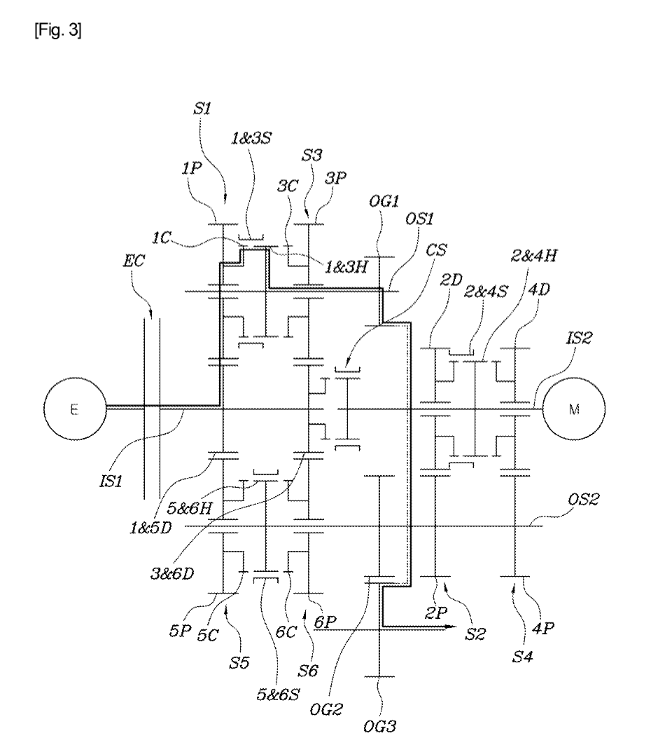

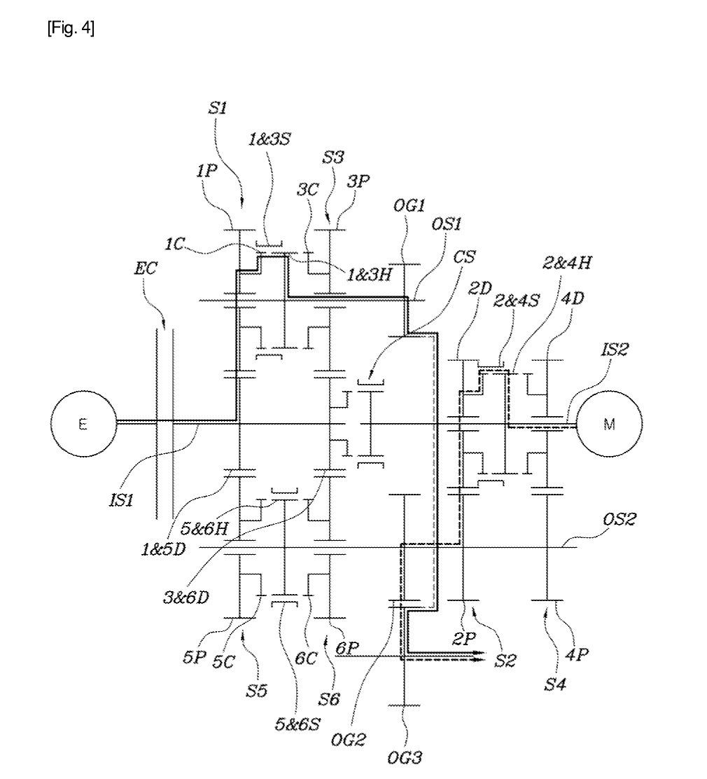

FIG. 3 illustrates a state converted from the state illustrated in FIG. 2 by coupling the second/fourth stage sleeve 2&4S with the second stage clutch gear 2C. In this state, power from the motor M is not yet supplied. FIG. 4 illustrates a state in which a drive is supplied from the motor M. The power generated by the motor M is initially at a level suitable to first stage driving and gradually converts to a level suitable to second stage driving.

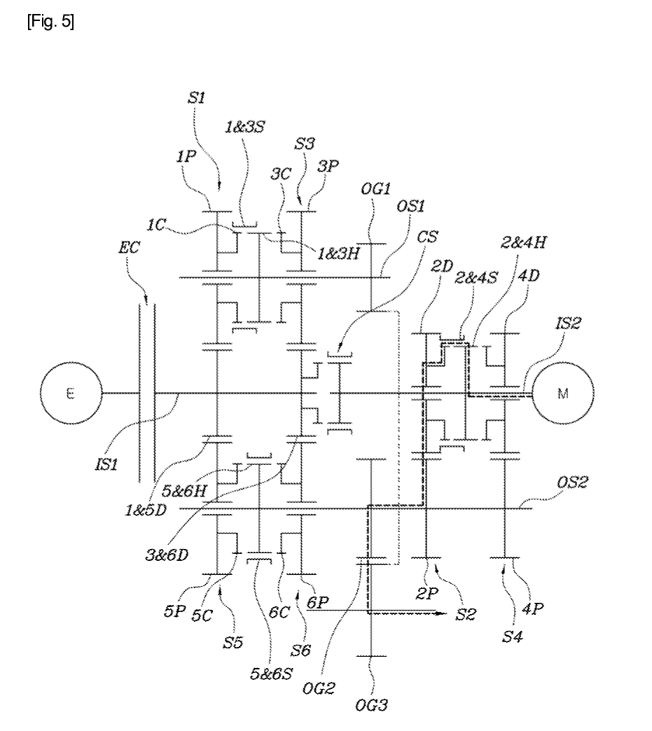

While the motor is being controlled in this manner, the engine clutch EC disconnects the engine E and the transmission as illustrated in FIG. 5, such that second stage driving is carried out by only the motor M.

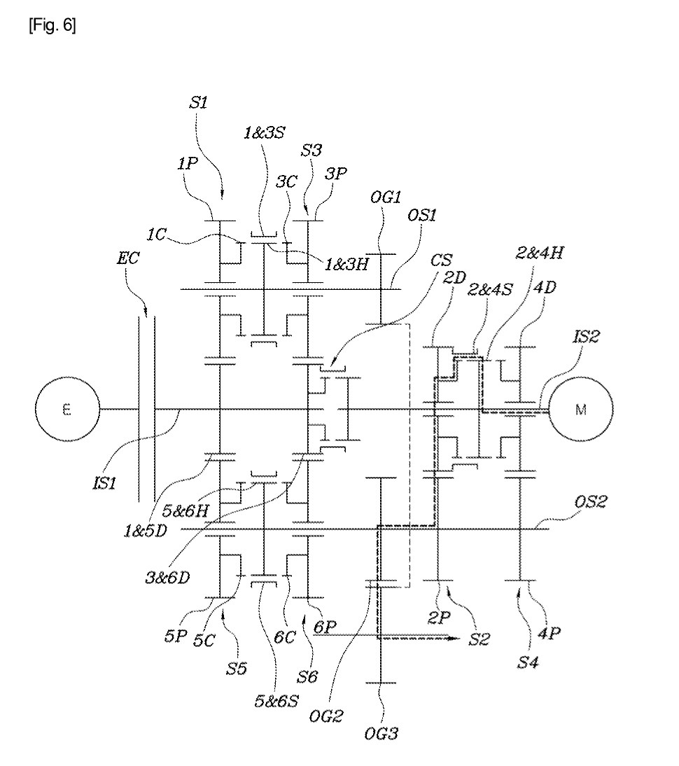

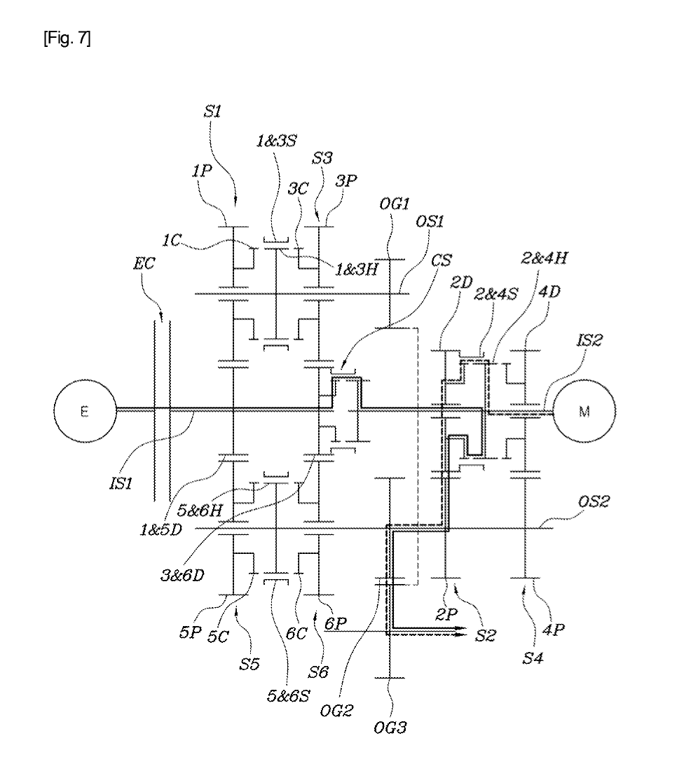

FIG. 6 illustrates a state converted from the state illustrated in FIG. 5 by disconnecting the first/third stage sleeve 1&3S from the first stage clutch gear 1C and engaging the first input shaft IS1 and the second input shaft IS2 by means of the center synchronizer CS. FIG. 7 illustrates a state converted from the state illustrated in FIG. 6 by connecting the engine E and the transmission by means of the engine clutch EC. In this state, power from the engine E and power from the motor M work together to enable second stage hybrid driving.

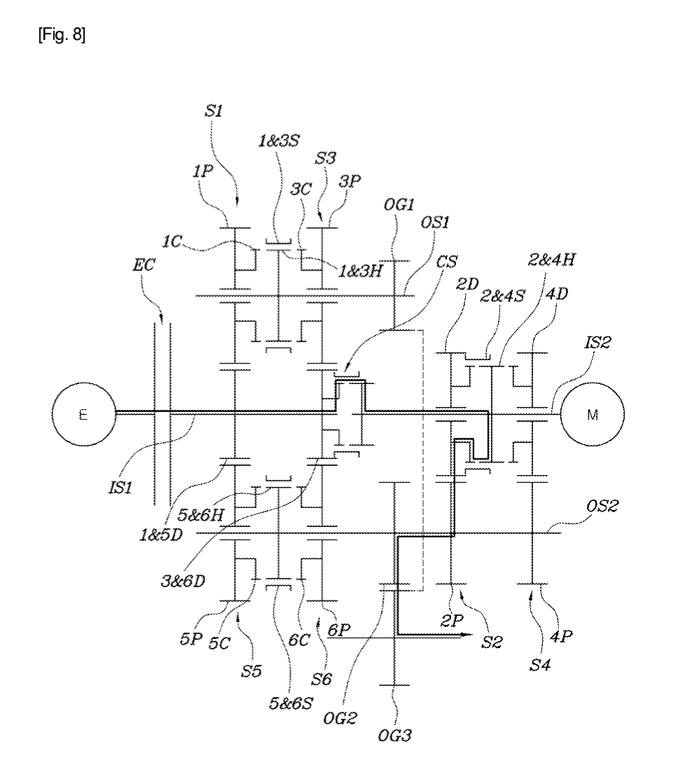

When the supply of power from the motor M is stopped in the state illustrated in FIG. 7, second stage driving is carried out by only the engine E as illustrated in FIG. 8.

In the above-described process of shifting from the first shifting stage to the second shifting stage, torque is continuously provided to the third output gear OG3, thereby removing torque interruption. This can consequently result in improved shifting quality, thereby improving the marketability of a vehicle.

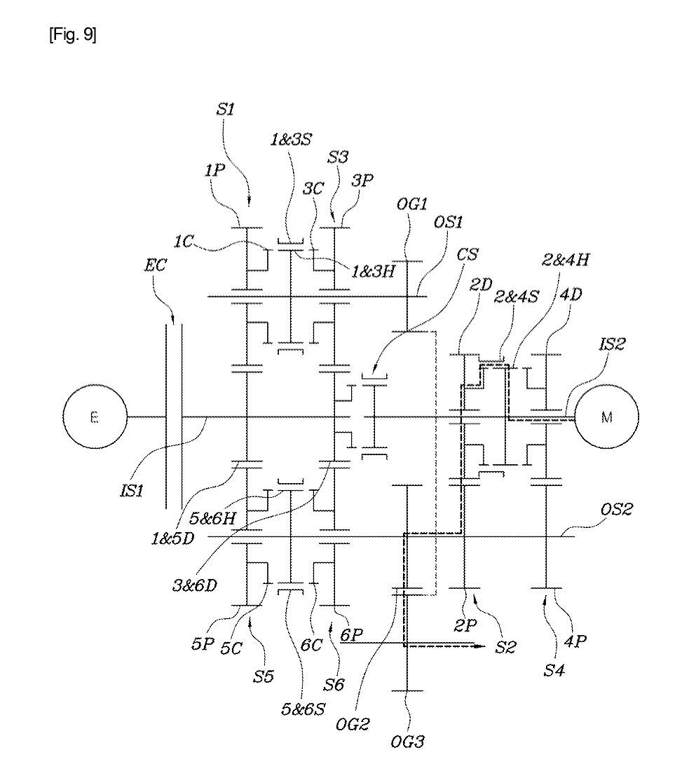

A process of shifting from a second shifting stage to a third shifting stage will be described with reference to FIGS. 9 to 12, the states of which are converted from the state of FIG. 8.

FIG. 9 illustrates second stage driving carried out by operating the motor M, converted from the state illustrated in FIG. 8. In this state, the engine clutch EC has disconnected the engine E and the transmission and the center synchronizer has disengaged the first input shaft IS1 and the second input shaft IS2.

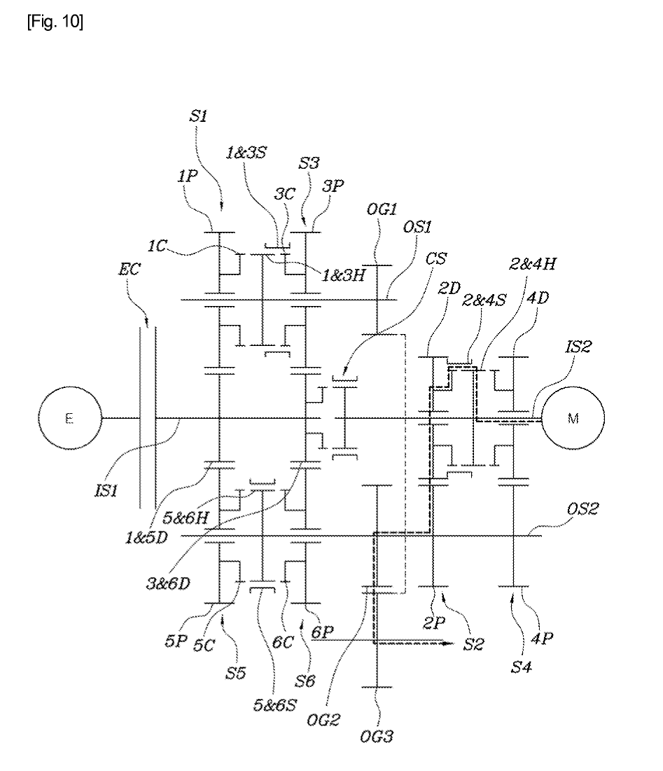

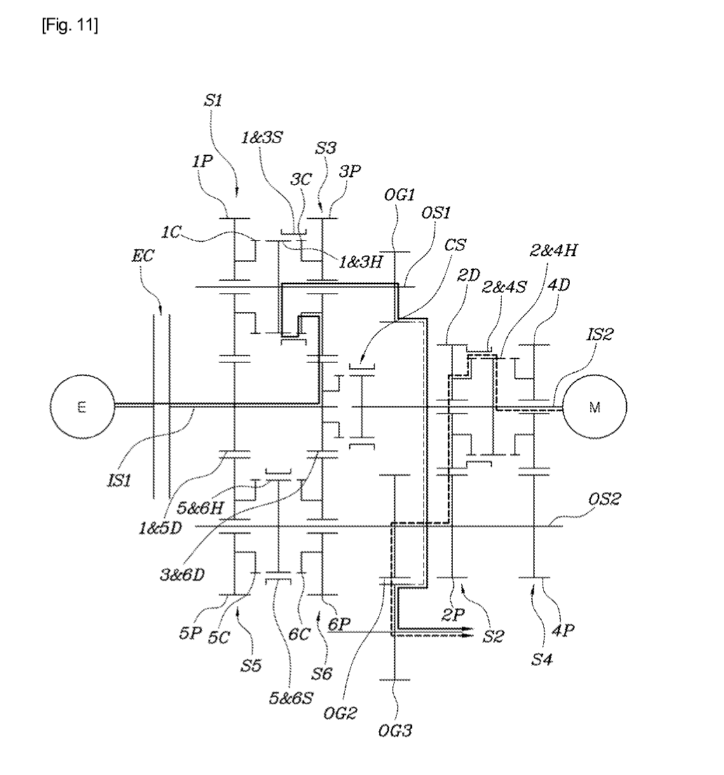

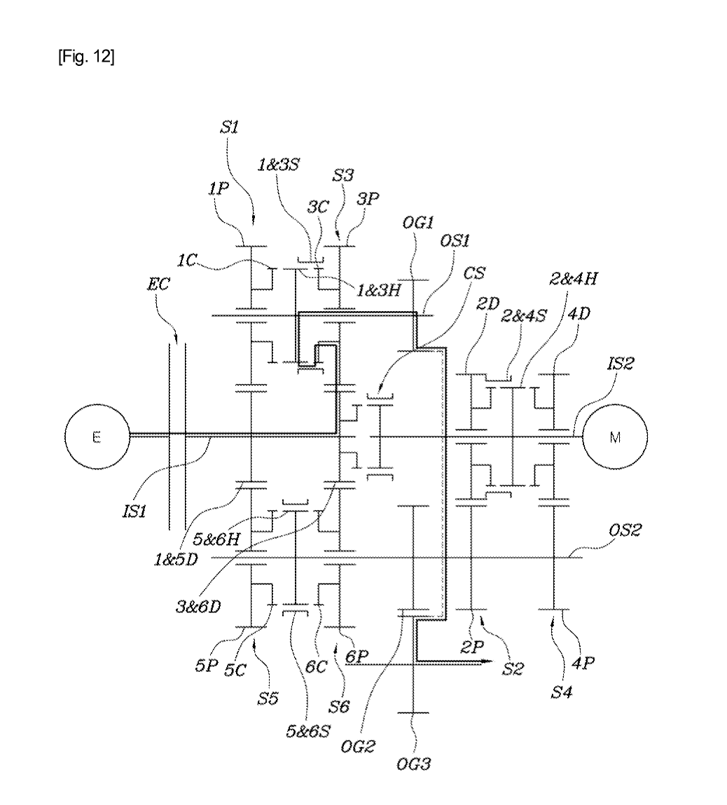

After the state illustrated in FIG. 9, the first/third stage sleeve 1&3S is connected to the third stage clutch gear 3C to be prepared for shifting to the third shifting stage, as illustrated in FIG. 10. When the engine clutch EC connects the engine E and the transmission as illustrated in FIG. 11, the third shifting stage is enabled, such that power from the engine E starts to be induced to the third output gear OG3. When power from the motor M is disconnected as illustrated in FIG. 12, third stage driving is carried out by the engine E. In this manner, power is continuously supplied to the third output gear OG3 during the process of shifting from the second shifting stage to the third shifting stage, thereby preventing torque interruption.

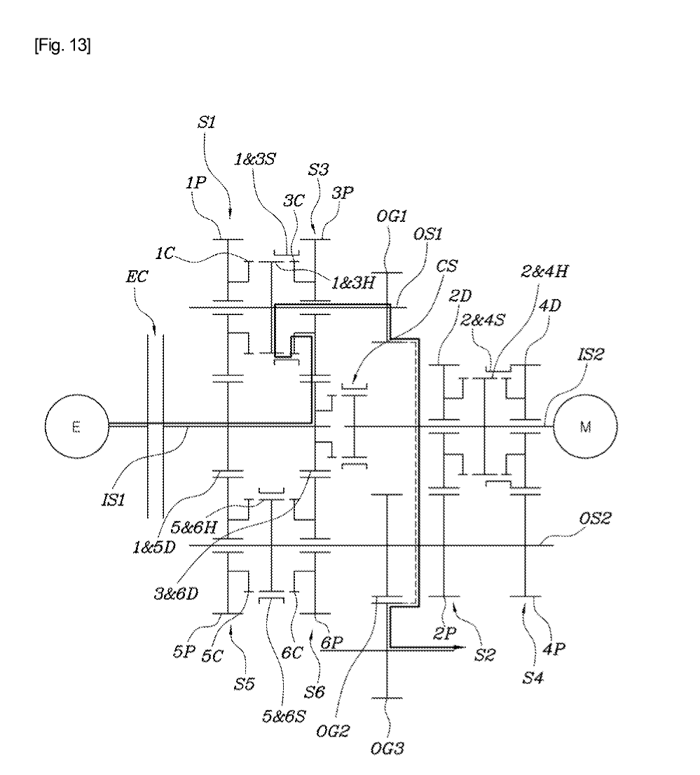

Referring to FIGS. 13 to 18, a process of shifting from the third shifting stage to the fourth shifting stage without torque interruption will be described.

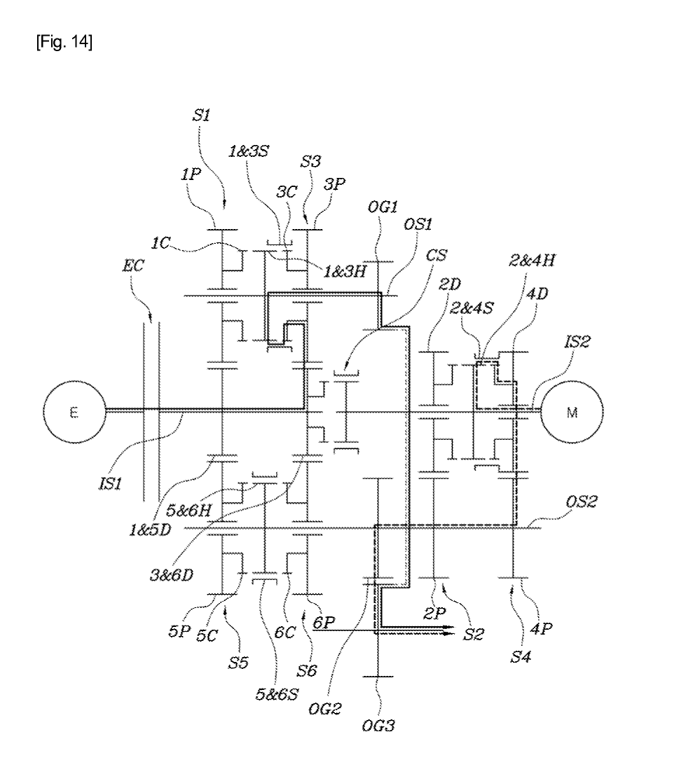

The state illustrated in FIG. 12 is converted to a state illustrated in FIG. 13 by coupling the second/fourth stage sleeve 2&4S with the fourth stage clutch gear 4C. Sequentially, as illustrated in FIG. 14, the motor M is operated, such that fourth stage power is transmitted to the third output gear OG3.

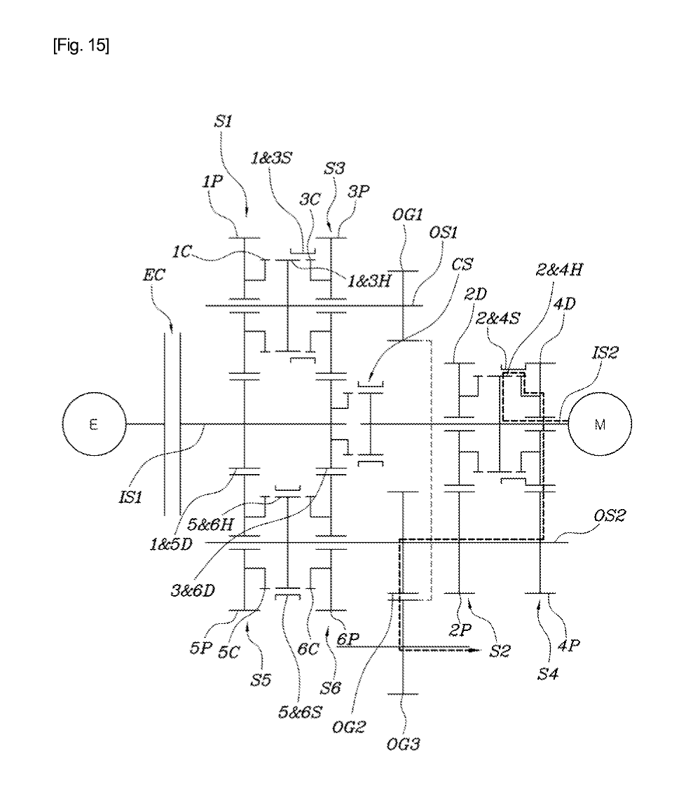

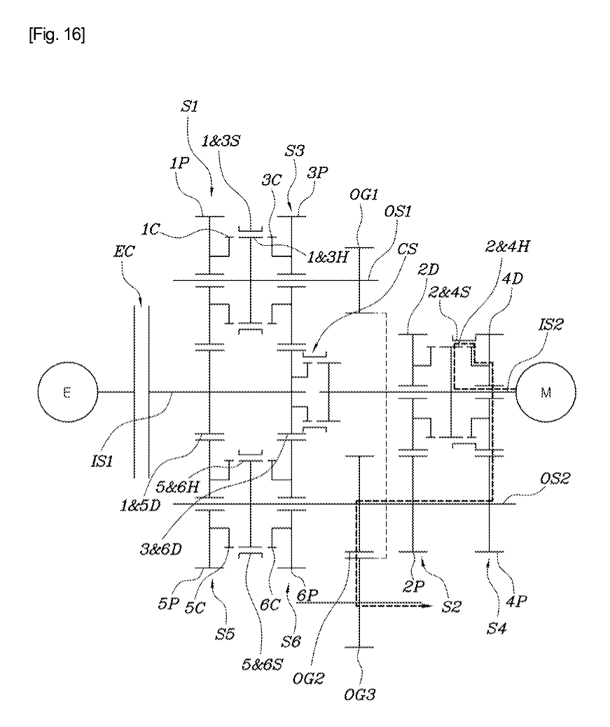

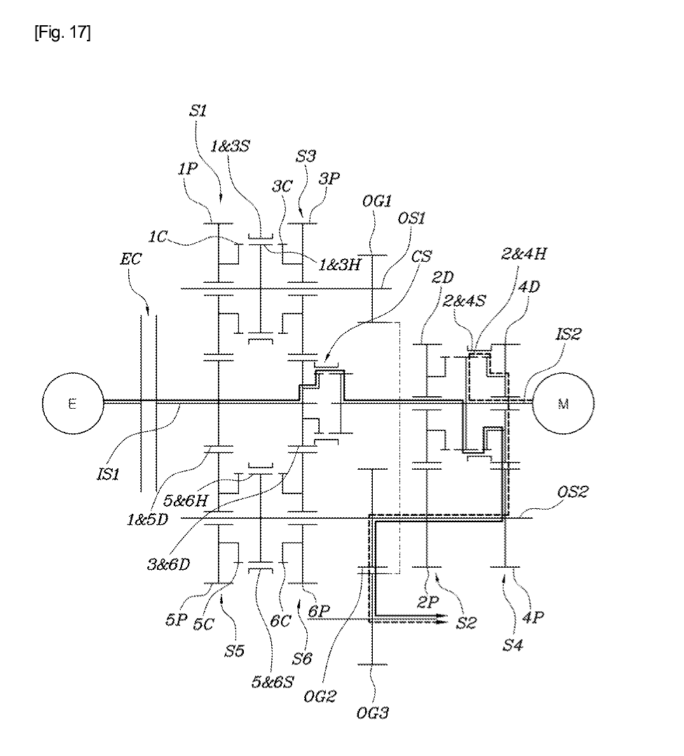

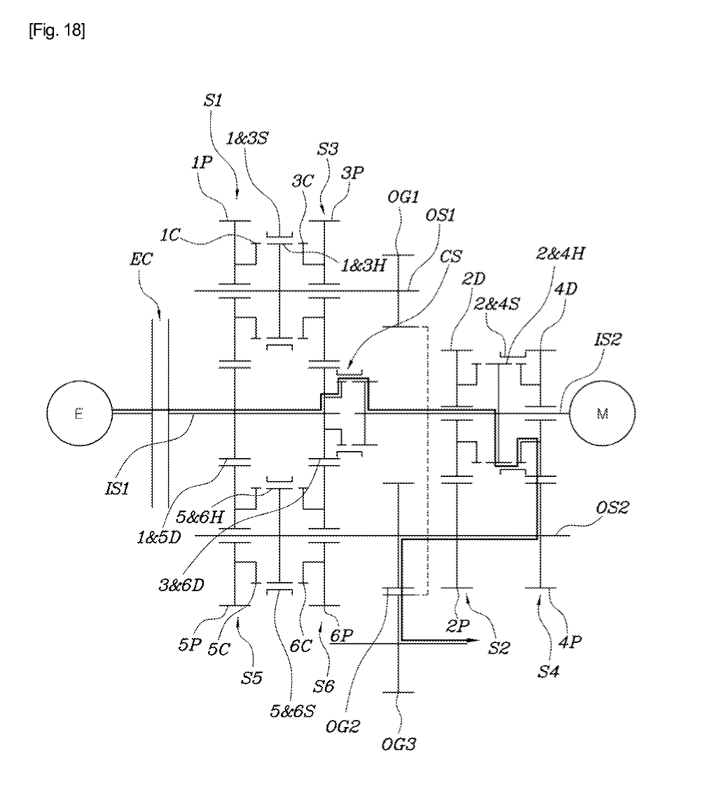

In the state illustrated in FIG. 14, the vehicle already starts to travel at a fourth shifting ratio, enabled by the motor M. In order to enable the fourth shifting stage by only the engine E, the engine clutch EC disconnects the engine E and the transmission as illustrated in FIG. 15, the first/third stage sleeve 1&3S is disconnected from the third stage clutch gear 3C and is set to a neutral position as illustrated in FIG. 16 and subsequently the center synchronizer CS engages the first input shaft IS1 and the second input shaft IS2, and the engine clutch EC connects the engine E and the transmission as illustrated in FIG. 17. Consequently, power from the engine E works together with power from the motor M to enable shifting to the fourth shifting stage, such that resultant power is induced to the third output gear OG3. Afterwards, when the supply of power from the motor M is stopped as illustrated in FIG. 18, fourth stage driving is carried out by only the engine E.

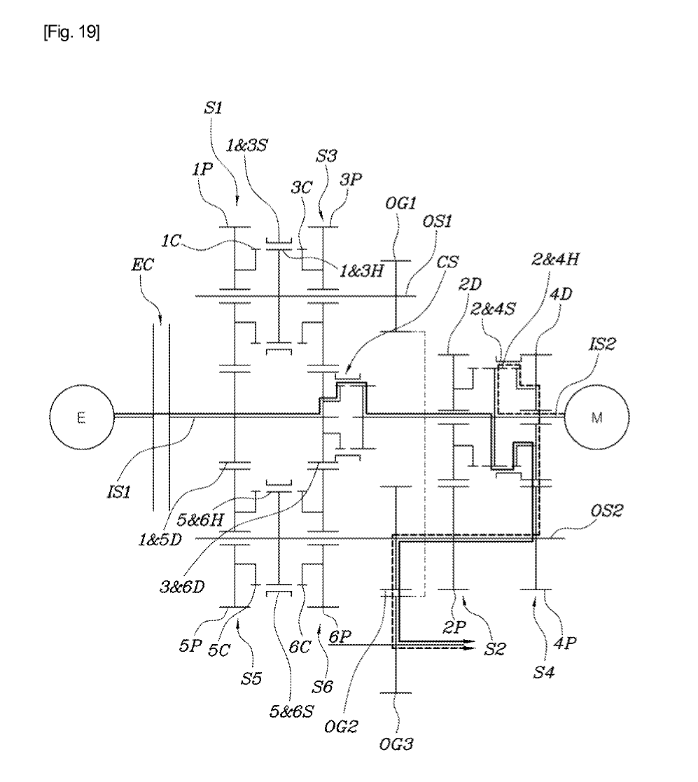

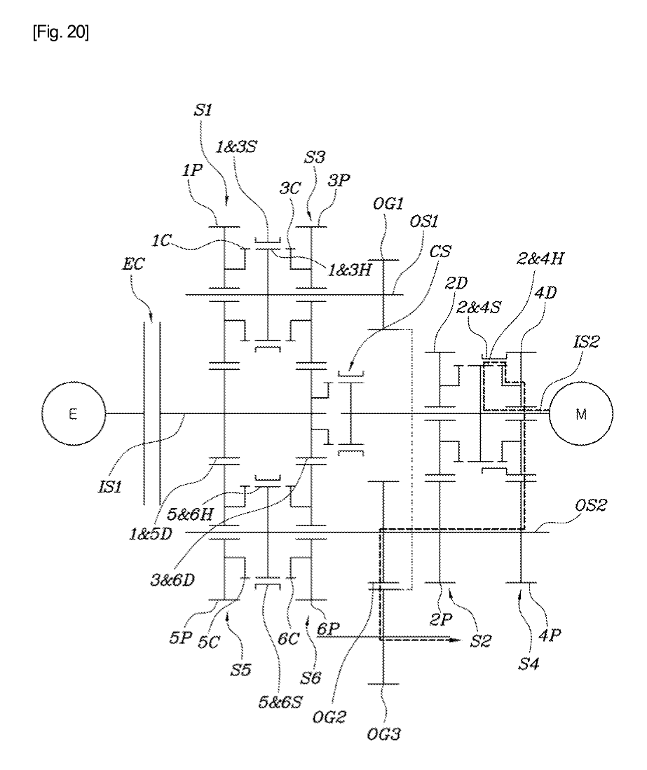

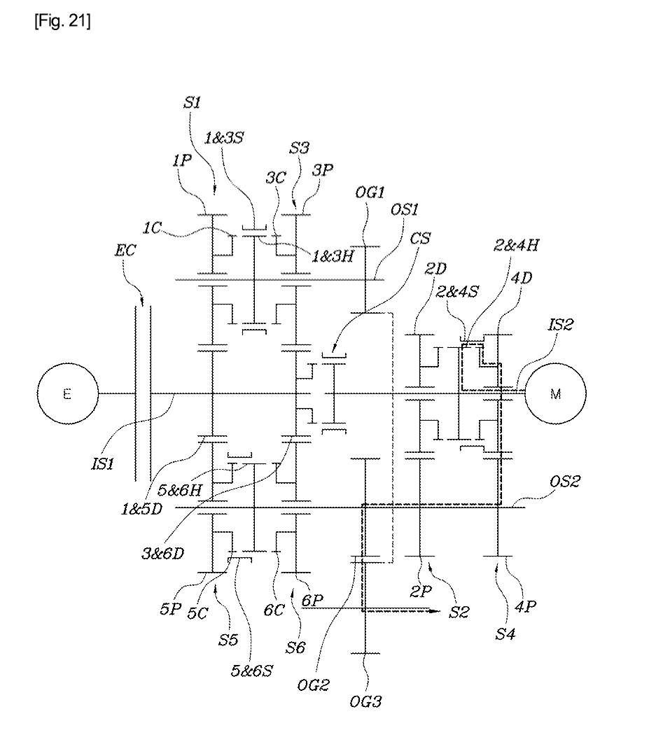

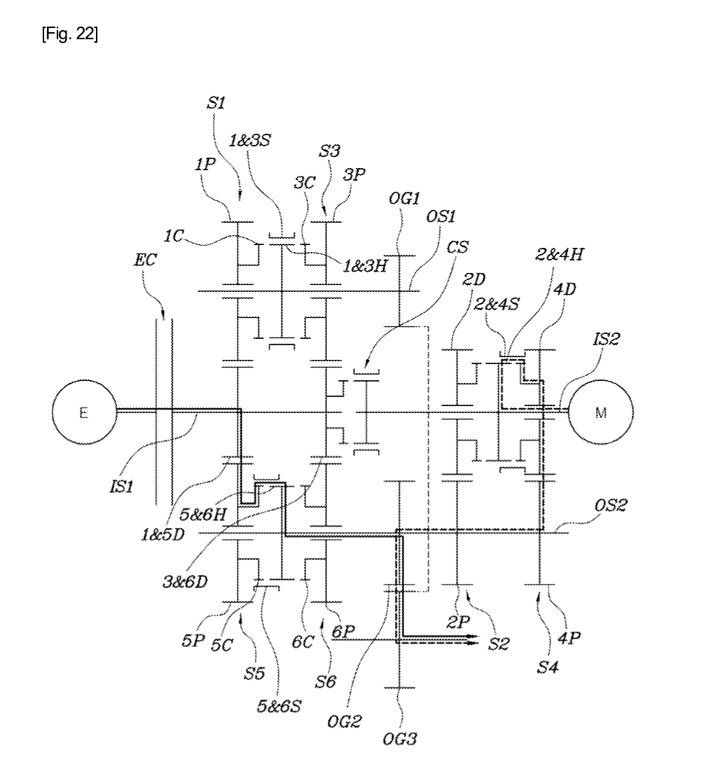

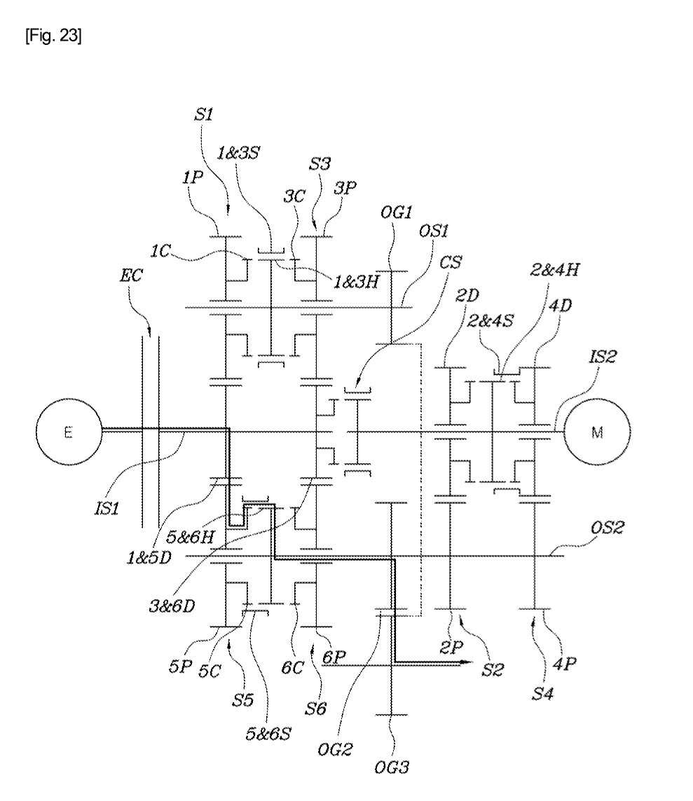

FIGS. 19 to 23 illustrate a process of shifting from the fourth shifting stage to the fifth shifting stage. The state illustrated in FIG. 18 is converted to the state illustrated in FIG. 19 by operating the motor M again. While fourth stage power is being supplied by the motor M, the engine clutch EC disconnects the engine E and the transmission and the center synchronizer CS disengages the first input shaft IS1 and the second input shaft IS2 as illustrated in FIG. 20. The fifth/sixth stage sleeve 5&6S is coupled with the fifth stage clutch gear 5C, as illustrated in FIG. 21. Afterwards, the engine clutch EC connects the engine E and the transmission, as illustrated in FIG. 22. Consequently, after shifting to the fifth shifting stage, power from the engine E is induced to the third output gear OG3. In this state, when the supply of power from the motor M is stopped as illustrated in FIG. 23, fifth stage driving is carried out by only the engine E.

According to the form of the present disclosure as described above, torque interruption does not occur during shifting between the adjacent shifting stages over the first to fifth shifting stages. This consequently contributes to an improvement in the shifting quality of a vehicle.

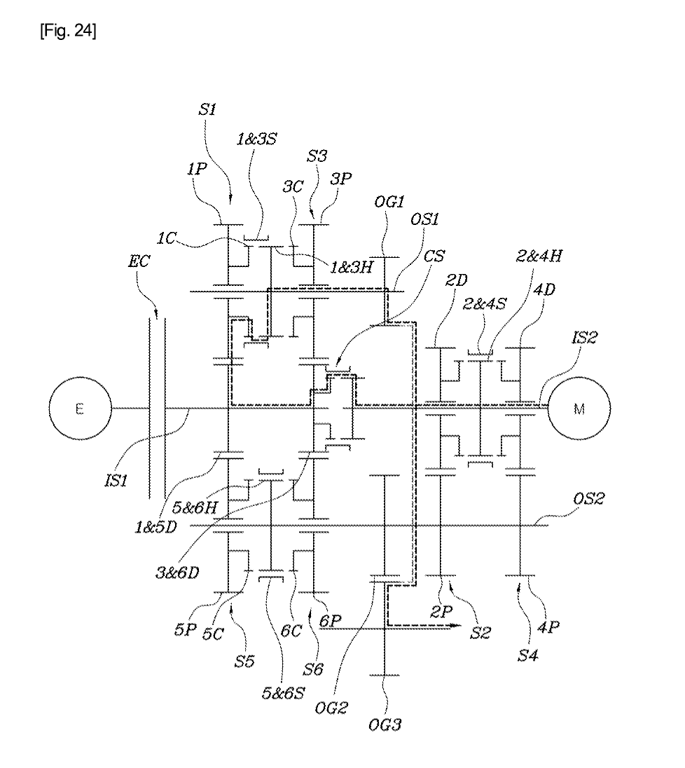

FIGS. 24 to 29 illustrate a flow of power when first to sixth shifting stages of pure electric vehicle (EV) mode are realized according to one form of the present disclosure.

FIG. 24 illustrates the first shifting stage of the EV mode, in which power from the motor M is transmitted to the first input shaft IS1 through the center synchronizer CS, is changed in speed by means of the first/fifth stage driving gear 1&5D and the first stage driven gear 1P, and subsequently is induced to the third output gear OG3 through the first output shaft OS1 and the first output gear OG1.

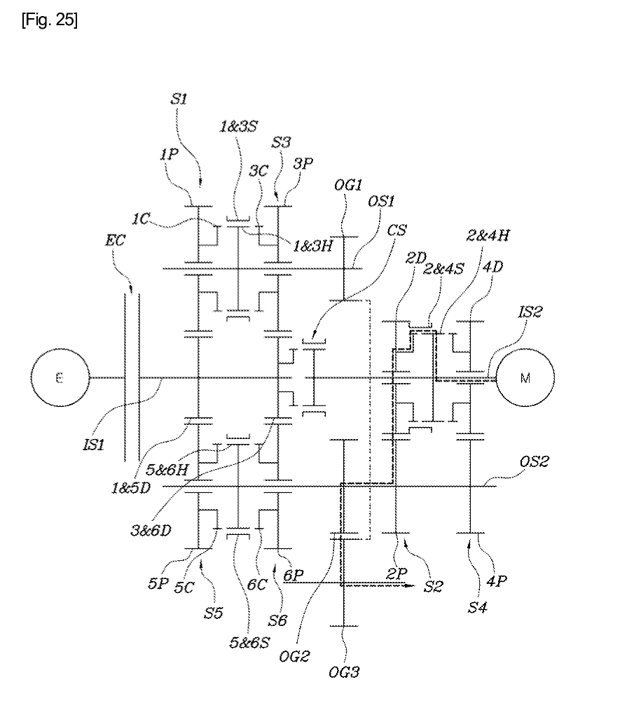

FIG. 25 illustrates the second shifting stage of the EV mode, in which the center synchronizer CS disengages the first input shaft IS1 and the second input shaft IS2. In this state, power transmitted through the second input shaft IS2 from the motor M is shifted to the second shifting stage by means of the second stage driving gear 2D and the second stage driven gear 2P, and is subsequently induced to the third output gear OG3 through the second output shaft OS2 and the second output gear OG2.

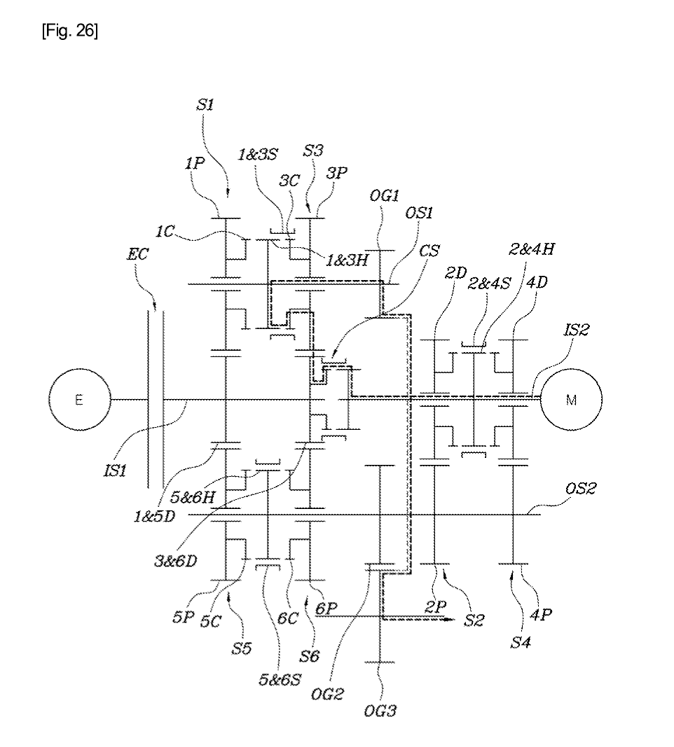

FIG. 26 illustrates the third shifting state of the EV mode. In this state, power on the second input shaft IS2 is transmitted to the first input shaft IS1 through the center synchronizer CS, is shifted by means of the third/sixth stage driving gear 3&6D and the third stage driven gear 3P, and consequently is induced to the third output gear OG3 through the first output shaft OS1.

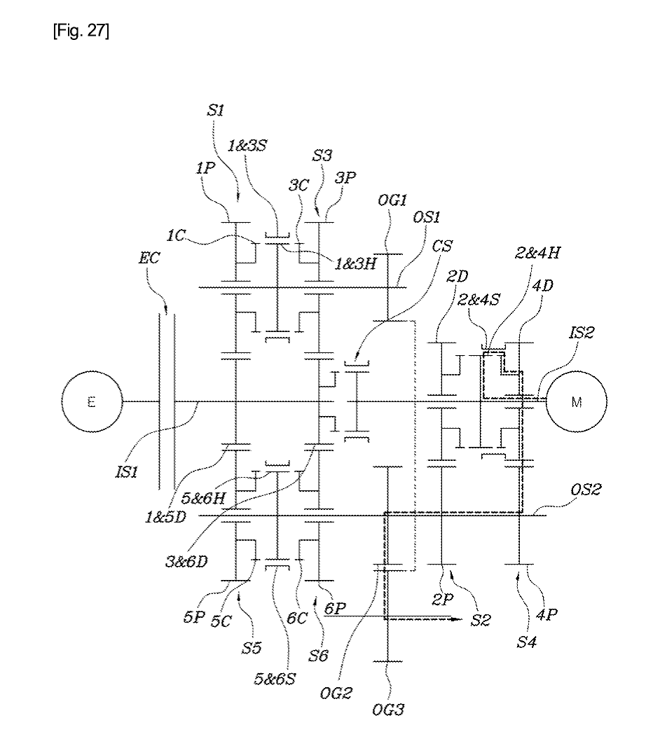

FIG. 27 illustrates the fourth shifting stage of the EV mode. In this state, power from the motor M is shifted by means of the fourth stage driving gear 4D and the fourth stage driving gear 4P and subsequently is induced to the third output gear OG3 through the second output shaft OS2 and the second output gear OG2.

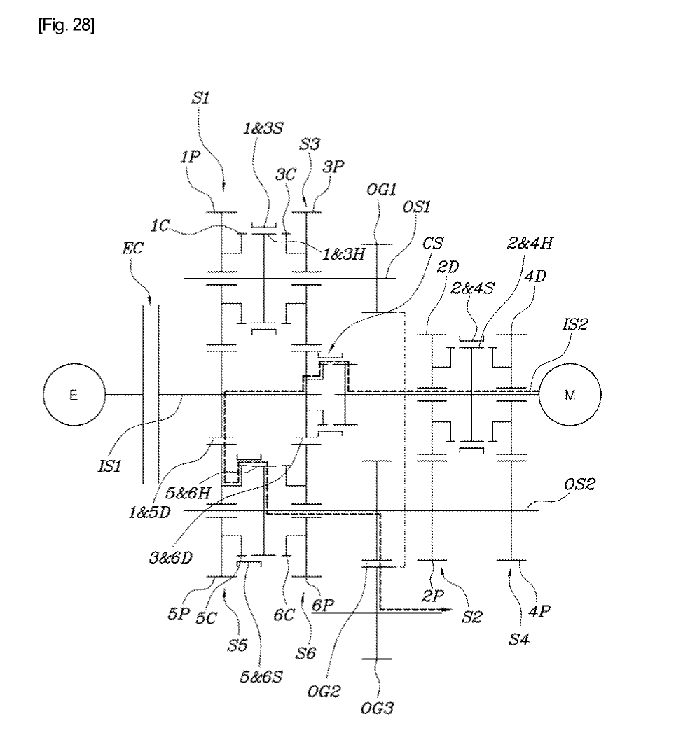

FIG. 28 illustrates the fifth shifting stage of the EV mode. In this state, power transmitted to the first input shaft IS1 through the center synchronizer CS from the motor M is shifted by means of the first/fifth stage driving gear 1&5D and the fifth stage driven gear 5P, and subsequently is induced to the third output gear OG3 through the second output shaft OS2 and the second output gear 2OG.

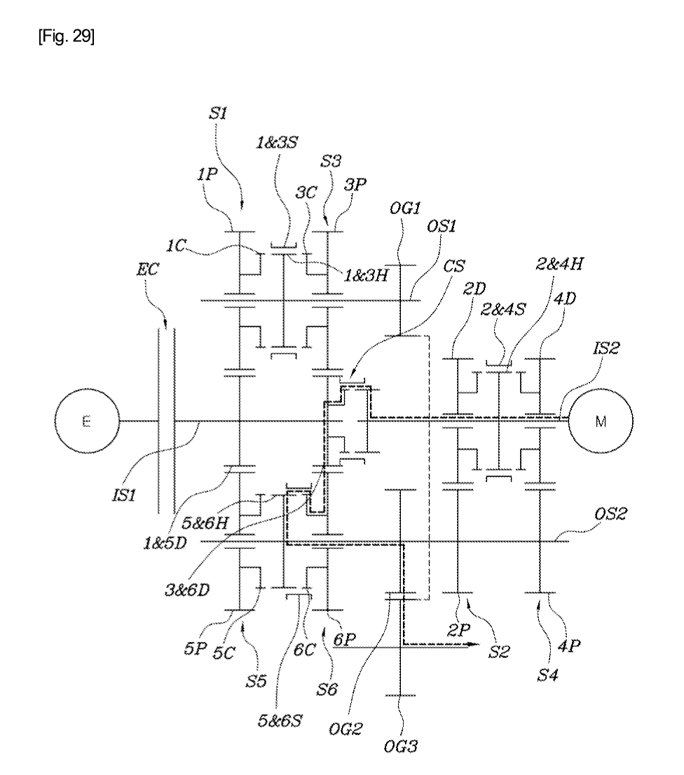

FIG. 29 illustrates the sixth shifting stage of the EV mode. In this state, power transmitted to the first input shaft IS1 through the center synchronizer CS from the motor M is shifted by means of the third/sixth stage driving gear 3&6D and the sixth stage driven gear 6P, and subsequently is induced to the third output gear OG3 through the second output shaft OS2 and the second output gear 2OG.

The transmission according to the present disclosure can realize all shifting stages of hybrid electric vehicle (HEV) mode, in which the vehicle is propelled by both the engine and the motor, by supplying power from not only the motor but also the engine in all shifting stages of EV mode in the state in which the engine clutch has connected the engine and the transmission and the center synchronizer has engaged the first input shaft and the second input shaft.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A hybrid transmission for a vehicle having an engine, the hybrid transmission comprising:
an engine clutch configured to connect and disconnect the engine to and from the transmission;
a first input shaft configured to receive power from the engine through the engine clutch;
a second input shaft coaxial with the first input shaft and connected to a motor;
a shaft-coupling unit configured to connect and disconnect the first input shaft and the second input shaft;
a first output shaft and a second output shaft respectively disposed parallel to the first input shaft and the second input shaft; and
a plurality of shifting units comprising constantly-engaging shifting mechanisms provided on the first input shaft and the first output shaft, on the first input shaft and the second output shaft, and on the second input shaft and the second output shaft, thereby forming a series of shifting stages, wherein shifting ratios of the series of shifting stages decrease with increasing numerical values of the series of shifting stages such that a first shifting stage has a greatest shifting ratio,
wherein the shifting units forming odd-numbered shifting stages of the series of shifting stages are disposed such that the odd-numbered shifting stages are realized by the first input shaft, and the shifting units forming even-numbered shifting stages of the series of shifting stages between the odd-numbered shifting stages are disposed such that the even-numbered shifting stages are realized by the second input shaft.

2. The hybrid transmission according to claim 1, wherein the shaft-coupling unit comprises a center synchronizer configured to engage and disengage the first input shaft and the second input shaft while synchronizing the first input shaft and the second input shaft by absorbing a difference in rotation speed therebetween.

3. The hybrid transmission according to claim 1, wherein each of the shifting units comprises a driving gear, a driven gear engaged with the driving gear, and a synchronizer connecting or disconnecting one of the driving gear and the driven gear to or from a shaft on which one of the driving gear and the driven gear is disposed.

4. The hybrid transmission according to claim 3, wherein the plurality of shifting units comprises a first, second, third, fourth, fifth, and sixth shifting unit to form a first, second, third, fourth, fifth, and sixth shifting stage, wherein the first shifting unit forming the first shifting stage and the third shifting unit forming the third shifting stage are disposed on the first input shaft and the first output shaft, the fifth shifting unit forming the fifth shifting stage and the sixth shifting unit forming the sixth shifting stage are disposed on the first input shaft and the second output shaft, and the second shifting unit forming the second shifting stage and the fourth shifting unit forming the fourth shifting stage are disposed on the second input shaft and the second output shaft.

5. The hybrid transmission according to claim 4, wherein the first shifting unit and the third shifting unit form a synchronizer commonly using a first/third stage hub and a first/third stage sleeve on the first output shaft, the second shifting unit and the fourth shifting unit form a synchronizer commonly using a second/fourth stage hub and a second/fourth stage sleeve on the second input shaft, and the fifth shifting unit and the sixth shifting unit form a synchronizer commonly using a fifth/sixth stage hub and a fifth/sixth stage sleeve on the second output shaft.

6. The hybrid transmission according to claim 1, wherein a first output gear is integrally disposed on the first output shaft, a second output gear is integrally disposed on the second output shaft, and a third output gear is engaged with the first and second output gears in order to receive power therefrom.
